(19) United States
(12) Patent Application Publication
(10) Pub. No.: US 2021/0324886 A1
(43) Pub. Date: Oct. 21, 2021

(54) ELECTRIC HEATER THAT CAN BE CLAMPED

(71) Applicant: Türk & Hillinger GmbH, Tuttlingen (DE)

(72) Inventor: Andreas SCHLIPF, Tuttlingen (DE)

(21) Appl. No.: 17/229,776

(22) Filed: Apr. 13, 2021

(30) Foreign Application Priority Data
Apr. 15, 2020 (DE) 20 2020 102 066.8

(51) Int. Cl. F16B 2/18; H05B 3/58

(52) U.S. Cl. CPC F16B 2/18; H05B 3/58

(57) ABSTRACT

An electric heater with an axial opening for holding an object to be heated includes an electric heating element and a clamping sleeve for generating an adjustable, radial force acting in a direction toward an axis of the axial opening. The clamping sleeve of the electric heating device is penetrated by at least one cut, whose width can be changed by means of at least one clamping device. A component of the clamping device is rotatably mounted or can be rotatably mounted relative to the clamping sleeve about an axis of rotation perpendicular to the axis of the axial opening. This component interacts directly or indirectly with the clamping sleeve so that a rotation of the rotatably mounted or rotatably mountable component of the clamping device changes the width of the cut.

### CROSS-REFERENCE TO RELATED APPLICATION

This application claims priority under 35 U.S.C. § 119 to German Patent Application No. 20 2020 102 066.8, filed on Apr. 15, 2020, the disclosure of which is incorporated herein by reference in its entirety.

### BACKGROUND OF THE INVENTION

From the prior art, heaters are known with an electric heating element, which are pushed onto a body to be heated and are fastened there by clamps. For example, such heaters are used in injection casting machines or in hot runner and distributor systems as a nozzle heating system for heating nozzle bodies.

From the prior art available on the market, it is already known to provide a clamping sleeve around the heating element, wherein this clamping sleeve is in direct or indirect contact with the heating element, e.g., by being embedded between an inner and an outer metal sleeve, and wherein this clamping sleeve has, viewed in the radial direction, overlapping sections, between which there is a wedge mechanism operated with a screw. If the screw is turned in one direction, the wedge mechanism moves so that its height changes, which leads to an increase in the distance of the overlapping sections of the clamping sleeve, resulting in a clamping of the heater on the body to be heated due to the essentially constant length of the clamping sleeve. Turning the screw in the other direction allows the clamping sleeve to be loosened again.

The design of this heater with clamping sleeve is problematic due to the increased space requirements caused by the wedge mechanism in the radial direction in the clamping mechanism, because, in many cases, especially for hot runner nozzles, the individual nozzles to be heated are arranged in blocks and between the nozzle and the block there is only a relatively narrow, tubular channel in which the heater must fit.

Especially for applications in which such increased space requirements cannot be made available, heating devices have been developed like those disclosed, for example, in DE 200 15 016 U1 or DE 20 2011 003 451 U1. In these heaters, the heating element is arranged between an inner and an outer metal sleeve and the heater has a slot penetrating completely through it in the axial direction. Furthermore, clamping elements are provided that interact with the outer metal sleeve so that their displacement in the axial direction changes the width of the slot in the peripheral direction, thus producing the clamping on the body to be heated.

One big problem in these heaters is operating the clamping elements, which, in many cases, must be manipulated within a narrow, tubular channel that is accessible only from one side after the heater has been pushed onto the body to be heated. It is then very difficult, for example, to loosen a clamping element again. It is also problematic to make heaters that can be clamped individually if the heater has a length that makes it necessary to arrange multiple clamping devices one after the other in the axial direction, in order to guarantee a sufficiently close contact between the heater and the object to be heated.

### BRIEF SUMMARY OF THE INVENTION

The objective of the invention is thus to disclose a heater that can be clamped and that provides for better operability of the clamping element. This objective is realized by a preferred heater with the features of the appended claims. Advantageous refinements of the invention are the subject matter of the dependent claims.

The electric heater according to the invention has an axial opening for holding an object to be heated, whose outer contour can be preferably cylindrical, an electric heating element—preferably surrounding the axial opening at least in sections—and a clamping sleeve—with a preferably cylindrical or truncated-cone-shaped form—for producing an adjustable, radial force acting in the direction toward the axis of the axial opening.

The following explanations are intended to contribute to a clearer understanding of this terminology:

The geometry of such a heater can be described preferably using terms for a cylinder from geometry or for a more generalized cylinder and cylindrical coordinates. The direction of the cylinder axis is specified by the axis that defines the axial opening of the heater, in which the object to be heated is usually pushed in, and will be designated below as the axial direction.

A force acts radially in the direction toward this axis when it acts in the direction toward the axis on a line perpendicular to this axis between a point of the cylinder sleeve and a point of the axis and thus is especially suitable for pressing the electric heater onto an object to be heated arranged in its axial opening.

The profile of an electric heating element in space can be described especially in cylindrical coordinates, that is, by the position on the axis of the axial opening, the distance in the radial direction from the axis of the axial opening and a polar angle between 0° and 360°. The electric heating element surrounds the axial opening at least in sections, when different polar angles for describing the profile of the electric heating element are in the area of the axial opening. In particular, this is the case when the side of the electric heating element facing the axial opening is on an imaginary cylindrical or truncated-cone-shaped surface, which surrounds the axial opening—preferably coaxially—which is, in turn, the case, in particular, when the electric heating element has a coiled or meandering profile on an imaginary cylindrical or truncated-cone-shaped sleeve, wherein the slope in the direction parallel to the cylindrical or truncated-cone-shaped axis can vary.

According to the invention, at least the clamping sleeve of the electric heater can be penetrated at least in sections by a cut, which can be realized, in particular, as a slot. A cut is to be understood, in particular, as an opening or through hole; groups of openings or through holes are also conceivable. The cut penetrates the clamping sleeve at least in sections and therefore does not necessarily have to extend over its entire length.

Here, the width of the cut or, in particular, of the slot, which can be understood as the distance of edge points of the cut opposite each other essentially perpendicular to the axis of the axial opening, can be changed by means of at least one clamping device.

An alternative description of the circumstances in which the width of the cut can be changed by means of the clamping device can also use a description of the cut in cylindrical coordinates: at each point of the cylinder axis at which a cut is present, this covers a defined range of polar angles. If the range of polar angles covered by the cut varies for different positioning of the clamping device at such points of the cylinder axis, the width of the cut can be changed by means of the clamping device.

A preferred portion the invention that at least one component of the clamping device is rotatably mounted or can be rotatably mounted relative to the clamping sleeve about an axis perpendicular to the axis of the axial opening, wherein this component interacts directly or indirectly with the clamping sleeve so that rotation of the rotatably mounted or rotatably mountable component of the clamping device changes the width of the cut or, in particular, the width of the slot.

It is to be noted, in particular, that the clamping sleeve can be realized, for different embodiments of electric heaters according to the invention, as a separate, additional component, but, on the other hand, also by different parts of the electric heater itself.

For example, for electric heaters in which the electric heating element is embedded in a powder or granulate with good heat-conducting properties, which fills the interior space between a tubular inner sleeve with a design that can have a slot and a tubular outer sleeve typically arranged concentric to the inner sleeve with a cut that can be formed as a slot, which can be connected to each other by lateral boundary surfaces at the edges of the cuts or the slots, the clamping sleeve can be formed by the tubular outer sleeve with a cut or slot.

For embodiments in which a coiled electric heating element in the form of a coiled tube cartridge is surrounded by a tubular outer sleeve with a cut, preferably in the form of a slot, with which it forms a direct contact, this can also form the clamping sleeve.

And for embodiments in which a coiled tube cartridge is inserted in a groove formed in a metal surface, wherein the metal surface is a surface of a metal body preferably in the form of a tube, in particular, slotted tube, wherein this shape can be machined, for example, from a solid body, but could also be produced by rolling a metal plate before or after the insertion of the coiled tube cartridge, this metal body can form the clamping sleeve.

Differently than for embodiments from the prior art, in which a linear motion is introduced directly, the construction according to the invention must perform a tool engagement only at one position that also remains stationary. Because the rotation can also be initiated not just with a tightening tool that has a straight shaft, but also with an angled tightening tool, the spatial requirements for operating such a clamping are also extremely small.

In a first type of clamping device, which has an especially simple construction, the rotatably mounted or rotatably mountable component of the clamping device is a disk with engagement means, wherein the engagement means interact directly or indirectly with complementary engagement means on the clamping sleeve.

It is to be noted that this type of clamping device can be constructed analogously also with geometric shapes other than a circular disk, for example, a square or a rectangle.

Here it is to be remarked that the difference between engagement means and complementary engagement means in this type is in the location at which the means are located and not in whether the means are a projection or a holder for such a projection. The engagement means are always on the disk; the complementary engagement means are always on the clamping sleeve.

Through the interaction of the engagement means and the complementary engagement means, the possibility is created for exerting a force on the clamping sleeve, wherein this force causes a reduction of the width of the cut, in particular, the slot, and therefore clamps the electric heater on the object to be heated.

In a first alternative, the engagement means can be, accordingly, projections that are, for example, pin-shaped, block-shaped, or curved, and the complementary engagement means can be recesses, in particular, cut-outs, grooves, or through holes, while, in a second alternative, the complementary engagement means can be projections and the engagement means can be recesses, in particular, cut-outs, grooves, or through holes.

Here it is advantageous if the projections, independent of whether they are engagement means or complementary engagement means, are formed by components fastened to the disk or components fastened to the clamping sleeve, that is, are not connected in one piece with the disk or the clamping sleeve. This can contribute significantly to an especially simple assembly of the clamping device.

This applies especially when the projections and the recesses are in contact with each other at least in sections in an undercut, so that the disk is fixed.

In general, for the movement of the disk, the projections are guided along a side edge of the recess facing the cut at least in sections. Because the position of the engagement means arranged on the disk is specified, a change of the distance of the points or areas on which engagement means and complementary engagement means are currently in contact with each other is realized in a change of the width of the cut in the clamping sleeve. If the recesses or the edges on which the projections contact or with which they interact have a curved profile, the movement of the disk can be especially smooth. In particular, this is the case when the curvature of the recesses varies.

Special flexibility with respect to the construction and a simple production for the recesses can be achieved in that these form complementary engagement means arranged on the clamping sleeve and run in a separate part fixed on the clamping sleeve, which is consequently not connected in one piece with the clamping sleeve.

To be able to introduce the rotational movement in an especially simple way, it is advantageous if the clamping device has a tool fitting that is on the axis of rotation of the rotatably mounted component of the clamping device. For example, such a tool fitting could be a slot or cross slot for holding a screwdriver, or a square, hexagonal, or star-shaped cut for holding a square key wrench, an Allen key, or a star key wrench.

To keep the necessary installation space low, it is advantageous if the clamping sleeve has a recess, in which the clamping device is arranged at least in sections.

For a second type of clamping device, it is provided that the complementary engagement means arranged on the clamping sleeve bridge the cut, which can be constructed, in particular, as a slot, with a first end that is connected to the clamping sleeve on one side of the cut and a second end that engages in the disk or in which the disk engages on the other side of the cut.

While for the first type of clamping device discussed above, the disk bridges the cut or optionally its special construction as a slot, this is provided in the second type by the complementary engagement means, which are formed correspondingly for this type not just by a projection or a cut on the clamping sleeve, but instead, for example, by a band-shaped structure bridging the recess, which has, on the end interacting with the disk, e.g., a projection or a recess, with which engagement means provided on the disk, e.g., in the form of a recess or a projection, are brought into engagement or indirectly, e.g., by means of a pin arranged on this end, while on the opposite end of the structure bridging the cut, a connection to the clamping sleeve is provided, which can likewise be realized, for example, by hooking a bent end of the structure bridging the clamping sleeve into a recess in the clamping sleeve.

For a third type of clamping device of an electric heater according to the invention, the clamping sleeve has a mount that defines an axis of rotation perpendicular to the axis of the axial opening, so that a component of the clamping device, which has a tooth structure on its periphery, can be mounted rotatably in the mount. The clamping sleeve further has complementary engagement means, whose distance from the cut or, if the cut is constructed as such, from the slot, increases from one end toward its other end.

The clamping device further has a clamping slide, wherein the clamping slide

has engagement means, which are in engagement with the engagement means of the clamping sleeve,
has an opening that runs parallel to the axis of the axial opening, and has at least one edge running parallel to the axis of the axial opening with a tooth structure complementary to the aforementioned tooth structure, and exposes the mount,
bridges the cut, and
is in contact or can be brought into contact with the clamping sleeve on the side of the cut opposite the engagement means.

As a consequence of this arrangement, it is produced that, if the component of the clamping device, which has a tooth structure on its periphery, is mounted rotatably in the mount and is turned, through the interaction of the tooth structure with the complementary tooth structure, the clamping slide is displaced in the axial direction and therefore the width of the cut is changed at least on one part of the axial displacement path.

In particular, for this third type of clamping device there is the ability that the component of the clamping device, which has a tooth structure on its periphery, is not arranged permanently on the electric heater, but instead only when a change of the tensioning effect is to be produced. In particular, the component of the clamping device, which has the tooth structure on its periphery, can thus be formed by a tool that is, in perhaps the simplest case, just a star key wrench.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1a: An exploded-view side perspective diagram of a first electric heater with a clamping device according to a first embodiment of the preferred invention,

FIG. 1b: an external side perspective view of the assembled electric heater from FIG. 1a,

FIG. 1c: a cross-sectional view of a detail of the clamping device from FIG. 1b,

FIG. 1d: an enlarged side perspective and exploded view of components of the clamping device of the electric heater from FIG. 1a,

FIG. 1e: an enlarged side perspective and exploded view of the components of a first variant of the clamping device of the first type of FIG. 1d,

FIG. 2: a series of illustrations of the functioning of the clamping device of the first type of FIG. 1d with reference to a second variant of such a clamping device

FIG. 3a: one option for assembling a clamping device of the first type with reference to a third variant of such a clamping device,

FIG. 3b: an enlarged side perspective, exploded and partial cross section through the assembled clamping device from FIG. 3a,

FIG. 4a: an external side perspective view of a second embodiment of an electric heater with a fourth variant of a clamping device of the first type,

FIG. 4b: an enlarged cross section through the clamping device according to FIG. 4a,

FIG. 5a: an external side perspective view of a third embodiment of an electric heater with a fifth variant of a clamping device of the first type,

FIG. 5b: an enlarged cross section through the clamping device according to FIG. 5a,

FIG. 6a: a side perspective, partially exploded-view diagram of a fourth embodiment of an electric heater with a clamping device according to a second type,

FIG. 6b: an external side perspective view of the assembled electric heater from FIG. 6a,

FIG. 6c: a cross-sectional diagram of a detail of the clamping device from FIG. 6b,

FIG. 6d: an enlarged side perspective diagram of the clamping device from FIG. 6b in a non-clamped state,

FIG. 6e: an enlarged side perspective diagram of the clamping device from FIG. 6e in the clamped state,

FIG. 7a: an external side perspective view with an enlarged side perspective view of a portion of a fifth embodiment of an electric heater with a clamping device according to a third type, with a clamping tool removed from the electric heater,

FIG. 7b: an external side perspective view with an enlarged side perspective view of a portion of the electric heater from FIG. 7a in a state in which the clamping tool is inserted,

FIG. 7c: an enlarged side perspective diagram of the clamping device from FIG. 7b in a non-clamped state,

FIG. 7d: an enlarged side perspective diagram of the clamping device from FIG. 7c in the clamped state,

FIG. 8a: a top plan view of a clamping device with a first variant of a cut,

FIG. 8b: a top plan view of a clamping device with a second variant of a cut,

FIG. 8c: a top plan view of a clamping device with a third variant of a cut,

FIG. 8d: a top plan view of a clamping device with a fourth variant of a cut, and

FIG. 8e: a top plan view of a clamping device with a fifth variant of a cut.

### DETAILED DESCRIPTION OF THE INVENTION

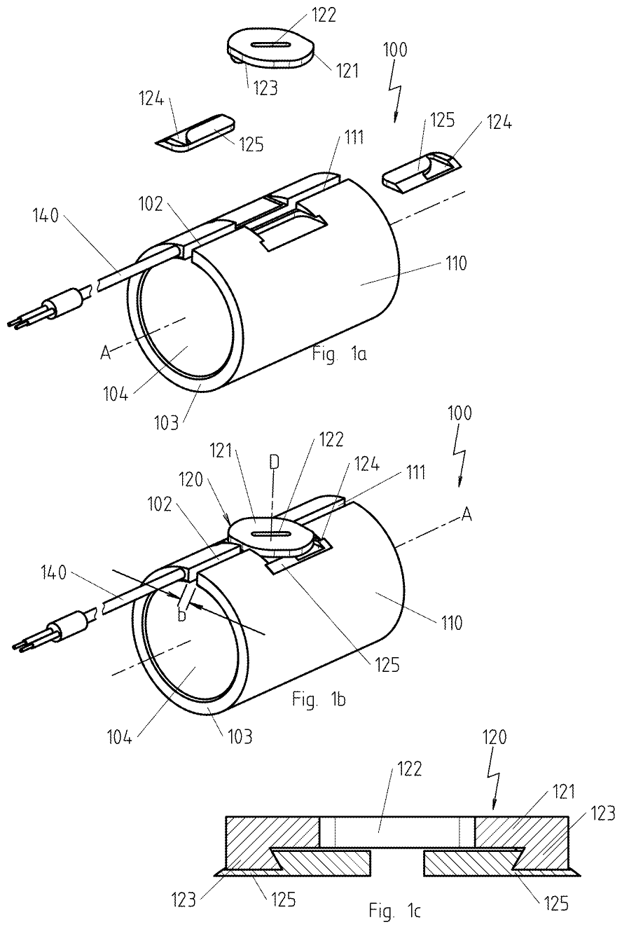

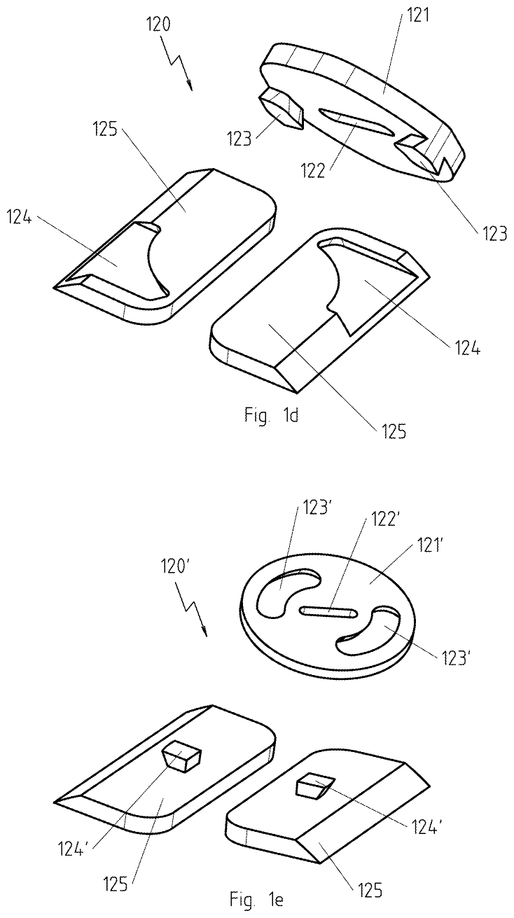

FIG. 1a shows an exploded-view diagram and FIG. 1b shows an external view of a first electric heater 100 with a clamping device 120 according to a first type. Here, the connecting lines with which the electric heater 100 is supplied with power are provided with the reference symbol 140.

The electric heater 100 essentially has the shape of a hollow cylinder with a slot, which forms the cut 111, penetrating longitudinally its profile direction specified by the cylinder axis that forms the axis A of the axial opening of the hollow cylinder. The electric heater 100 has a clamping sleeve 110, which simultaneously forms the outer sleeve of the hollow cylinder, which is connected by means of lateral boundary surfaces 102 of the slot forming the cut 111 and top or bottom lateral boundary surfaces 103 with the inner sleeve 104 of the hollow cylinder. In the interior space defined by these sleeve or boundary surfaces, the electric heating element not visible in the figures is embedded in a powder or granulate with good heat-conducting properties and arranged electrically insulated from the sleeve or boundary surfaces.

The clamping device 120, whose individual parts can be seen particularly well in FIG. 1d, has a disk 121, in which a tool fitting 122, which is designed here for a screwdriver, is formed and which is mounted rotatable about the axis of rotation D perpendicular to the cylinder axis A. On the disk 121 there are engagement means 123, which taper from their end facing away from the disk 121 in the direction toward the disk 121. The associated complementary engagement means 114 are cuts formed in push-in pieces 125, whose wall slope is adapted to the tapering of the engagement means 123, so that an undercut is produced that can be seen well in the cross-sectional diagram of FIG. 1c and fixes the disk 121. The push-in pieces 125 are each pushed in to a stop 113 in a corresponding recess 119 of the clamping sleeve 110 and fixed there by projections 112.

If the disk 121 is turned in the clockwise direction starting from the opened start position shown in FIG. 1b, the engagement means 123 slide along the wall section 126 of the cuts, which is curved less than a circular arc whose radius corresponds to the distance between the axis of rotation D and the start position of the engagement means 123. Accordingly, a force is exerted on the push-in pieces 125, which moves them farther and is transferred via the stop 113 to the clamping sleeve 110; the width b of the slot that forms the cut 111 thus becomes smaller.

The variant of a clamping device 120′ shown in FIG. 1e, which is to be assigned to the same type, differs essentially in that the complementary engagement means 114′ provided on the push-in pieces 125′ are constructed as projections, while the engagement means 123′ provided on the disk 121′ are constructed as kidney-shaped openings opposite each other point-symmetric relative to the axis of rotation D with a curvature that is less than the curvature of a circular arc whose radius corresponds to the distance between the axis of rotation D and the start position of the complementary engagement means 114′. Accordingly, the distance between the end areas of the engagement means 123′ point-symmetric relative to each other is greater than the distance between their centers, so that the rotation of the disk 121′ forces a change in the width of the cut 111′.

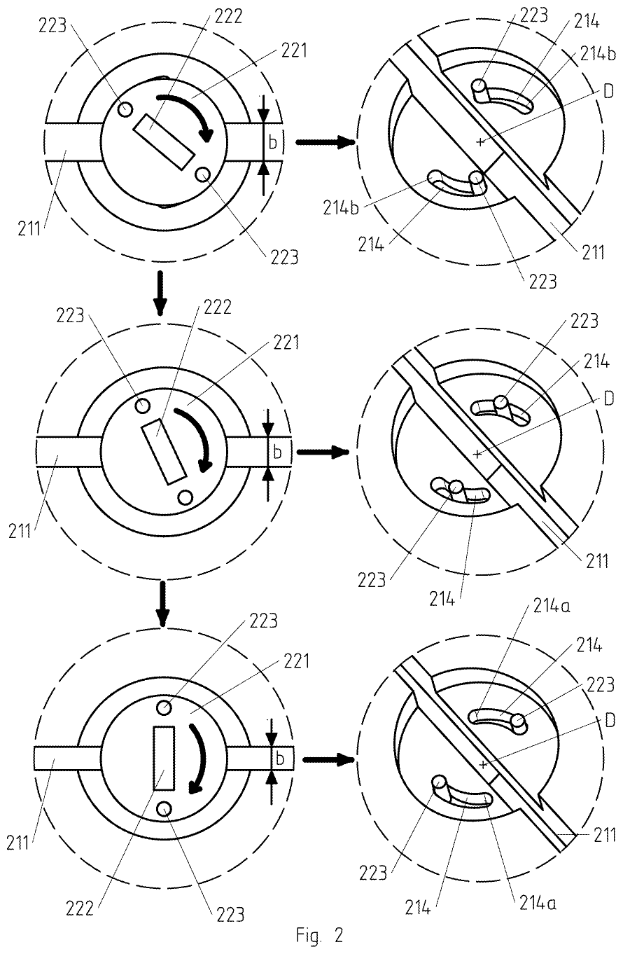

With reference to FIG. 2, the functionality of a clamping device of the first type can be illustrated again with reference to a second variant of such a clamping device 220 with a disk 221 with tool fitting 222 and engagement means 223 constructed as pins connected to the disk 221. Here, from top to bottom, three different settings of the clamping device 220 are shown, and each viewed from above on the left side and from below on the right side.

The complementary engagement means 214, in which the pins engage, are here curved slots in the clamping sleeve 210, which run on different sides of the cut 211 that penetrates the clamping sleeve 210 and is constructed as a slot, and point-symmetric relative to the axis of rotation D of the disk 221, such that the distance between the closer end areas 214a to the cut 211 constructed as a slot is less than the distance between the farther end areas 214b to the cut 211 constructed as a slot. Now, due to the rotational movement of the disk 221, the pins slide from the end area 214a of the complementary engagement means 214 in the direction toward the end area 214b, so the width b of the slot 211 is reduced and therefore a tensioning force is exerted.

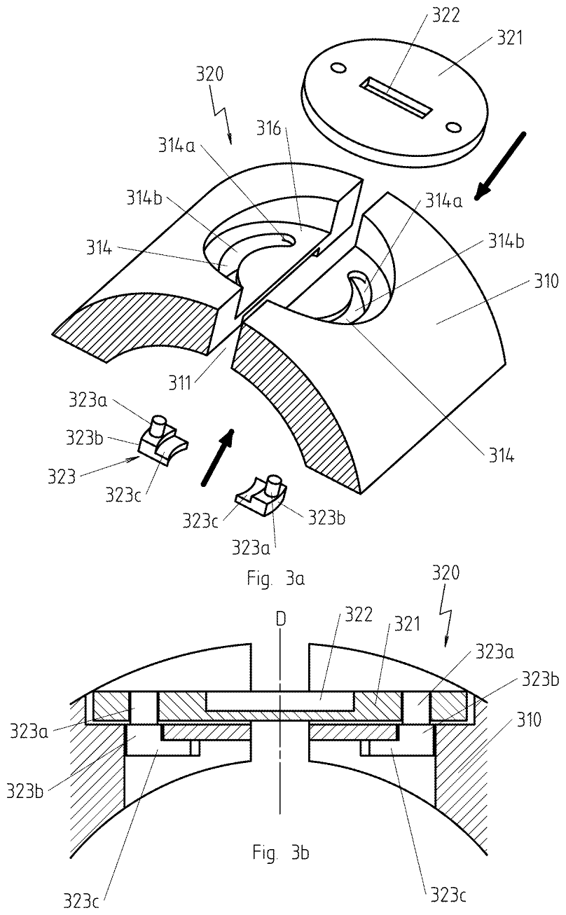

The clamping device 310 of the first type, which is shown in FIGS. 3a and 3b, is an example with a construction that provides for a very simple assembly of the clamping device 310. The complementary engagement means 314 are here also curved slots in the clamping sleeve 310, which run on different sides of the cut constructed as a slot in the clamping sleeve 310, and point-symmetric relative to the axis of rotation D of the disk 321, such that the distance between the closer end areas 314a to cut 311 constructed as a slot is less than the distance between farther middle sections 314b to cut 311 constructed as a slot. However, they are in a recess 319 formed in the clamping sleeve 310 for holding the disk 321, so that the clamping device 310 does not increase the diameter of an electric heater equipped with it.

The engagement means 323 here have an approximately L-shaped design, wherein the vertical bar of the L is formed by a bar-shaped fastening section 323a and a feedthrough section 323b and the horizontal bar of the L is formed by a projecting section 323c. After inserting the disk 321 into the recess 319, the engagement means 323 are guided from the inside of the clamping sleeve 310 through the complementary engagement means 314 formed as slots so that the projecting section 323c engages behind an edge of the slot and the feedthrough section 323b penetrates the slot, while the fastening section 323a engages in fastening openings 325, which are arranged in the disk. Then only the fastening section 323a must be fastened to the disk 321.

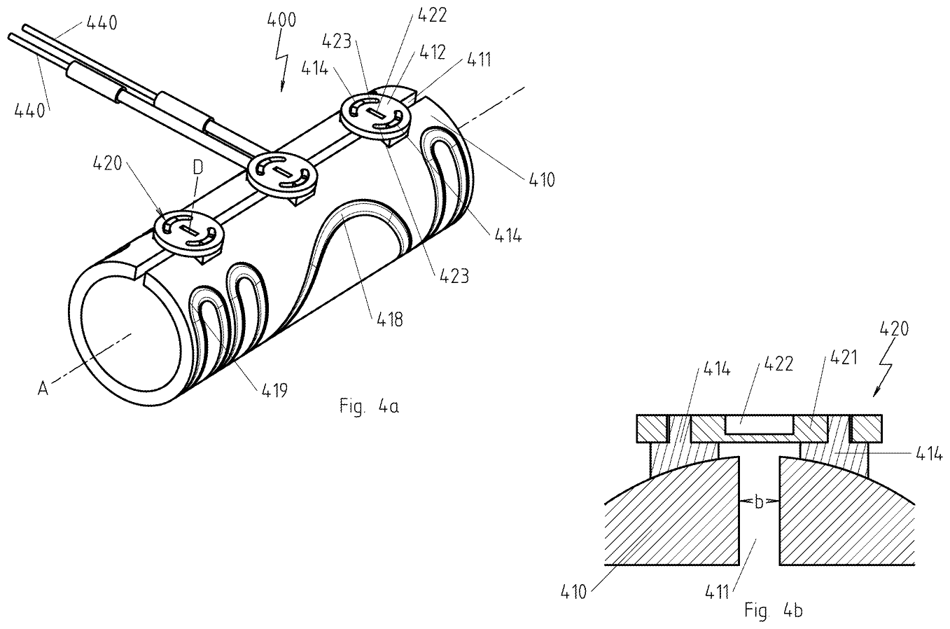

FIG. 4a shows an external view of a second electric heater 400 with a clamping sleeve 410, a cut 411 realized as a slot, and three clamping devices 420. In the clamping sleeve 410 there is a groove 419, in which an electric coiled tube cartridge is inserted as electric heating element 418.

The clamping devices 420 with disk 421, tool fitting 422, engagement means 423, and complementary engagement means 414 are constructed according to another variant of the first type, which, as can be easily seen in combination with the cross-sectional diagram of this clamping device 420 in FIG. 4b, essentially corresponds to the construction of the clamping device 120′ according to FIG. 1e; accordingly, the reference symbols are made by removing the ′ and adding 300 to the reference symbols from FIG. 1e. The difference is that the complementary engagement means 414 are set on the clamping sleeve 410 and not inserted into this sleeve.

Here, in FIG. 4a, the connecting lines 440 that supply the electric heater 400 with power are also shown.

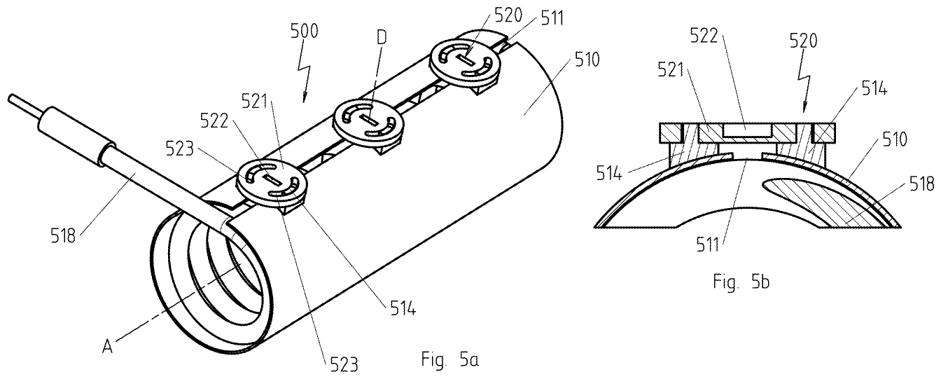

FIG. 5a shows an external view of a third electric heater 500 with a clamping sleeve 510, a cut 511 constructed as a slot, and three clamping devices 520. The clamping sleeve 510 surrounds the electric heating element 518 constructed as an electric coiled tube cartridge.

The clamping devices 520 with disk 521, tool fitting 522, engagement means 523, and complementary engagement means 514 are, as easily seen in combination with the cross-sectional diagram of the clamping device 520 in FIG. 5b, identical to the clamping devices discussed above; their reference symbols are made by adding 100 to the reference symbols of FIGS. 4a and 4b.

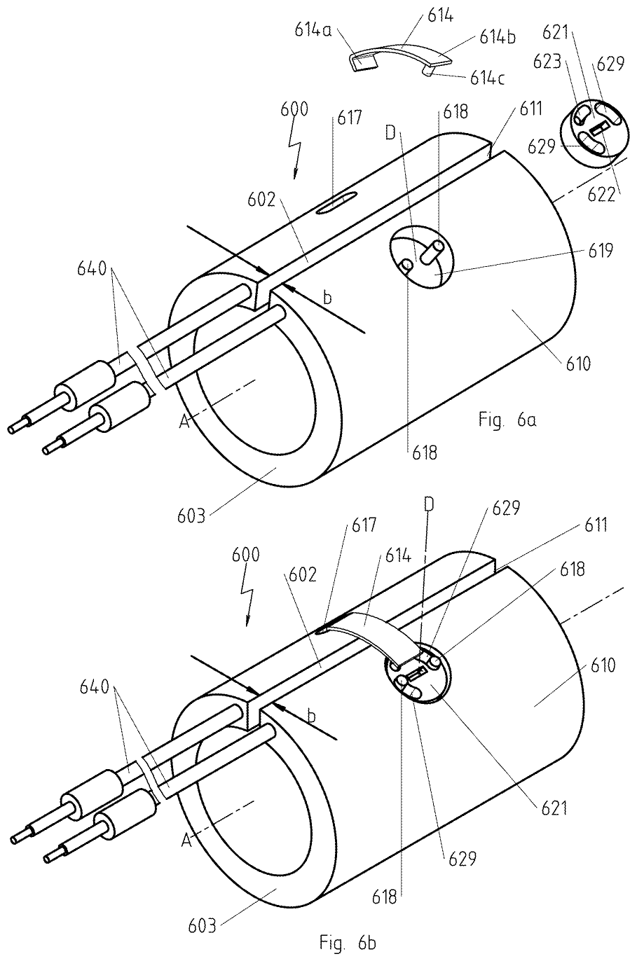

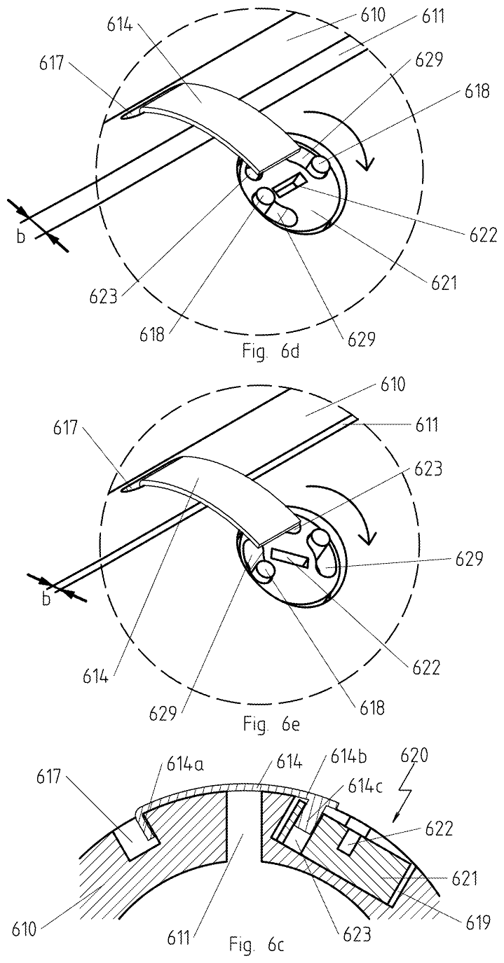

FIG. 6a shows an exploded-view diagram and FIG. 6b shows an external view of another electric heater 600 with a clamping device 620 according to a second type. Here, the connecting lines, with which the electric heater 600 is supplied with power, are provided with the reference symbol 640.

The electric heater 600 has essentially the shape of a hollow cylinder with a cut 611 also formed as a slot penetrating longitudinally through the cylinder axis that forms the axis A of the axial opening of the hollow cylinder. The electric heater 600 has a clamping sleeve 610 that simultaneously forms the outer sleeve of the hollow cylinder, which is connected by means of lateral boundary surfaces 602 of the recess 611 constructed as a slot and top and bottom lateral boundary surfaces 603 with the inner sleeve of the hollow cylinder. In the interior space defined by these sleeve or boundary surfaces, the electric heating element not visible in the figures is embedded in a powder or granulate with good heat-conducting properties and is electrically insulated from the sleeve or boundary surfaces.

The clamping device 620, whose individual parts are to be seen especially well in the exploded-view diagram of FIG. 6a and the cross-sectional diagram of FIG. 6c, has a disk 621, in which a tool fitting 622, which is here designed for a screwdriver, is formed and is rotatably mounted about the axis of rotation D perpendicular to the cylinder axis A. For this mounting there is, in the clamping sleeve 610, a recess 619, in which two guide pins 618 are arranged point-symmetric relative to the axis of rotation D. The disk has two circular arc-shaped through holes 629, which are likewise arranged point-symmetric relative to the axis of rotation D, whose distance from each other corresponds to the distance of the guide pins 618 and which are dimensioned so that the guide pins 618 are guided into the through holes 629 and is arranged in the recess 619 with guide pins 618 mounted in the through holes 629.

In addition, the disk 621 has, on its side facing the cut 611 constructed as a slot, engagement means 623, which are here constructed as a curved slot, whose distance to the edge of the disk 621 from its one end to its other end continuously increases. As a consequence of this construction, when the disk 621 rotates about the axis of rotation D, in which the guide pins 618 are guided in the through holes 629, the distance of the closest point of the curved slot of the engagement means 623 from the cut 611 constructed as a slot changes.

The complementary engagement means 614 are here a metal strip, which bridges the cut 611 realized as a slot. The angled-away first end 614a of this metal strip is connected to the clamping sleeve 610, in that it engages in an opening 617. The second end 614b of this metal strip arranged on the other side of the cut 611 constructed as a slot has a pin 614c, which engages in the engagement means 623 of the disk 621, that is, the curved slot.

As can be seen especially well in FIGS. 6d and 6e, it is realized that, when the disk 621 rotates—as explained above—the distance of the point of the curved slot that forms the engagement means 623 from the cut 611 constructed as a slot is changed, and also the position of the pin 614c from the cut 611 is changed, and the resulting tensile force acting via the metal strip, which forms the complementary engagement means 614, is transferred to the other side of the cut 611 constructed as a slot, which leads to a reduction of the width b of the cut 611.

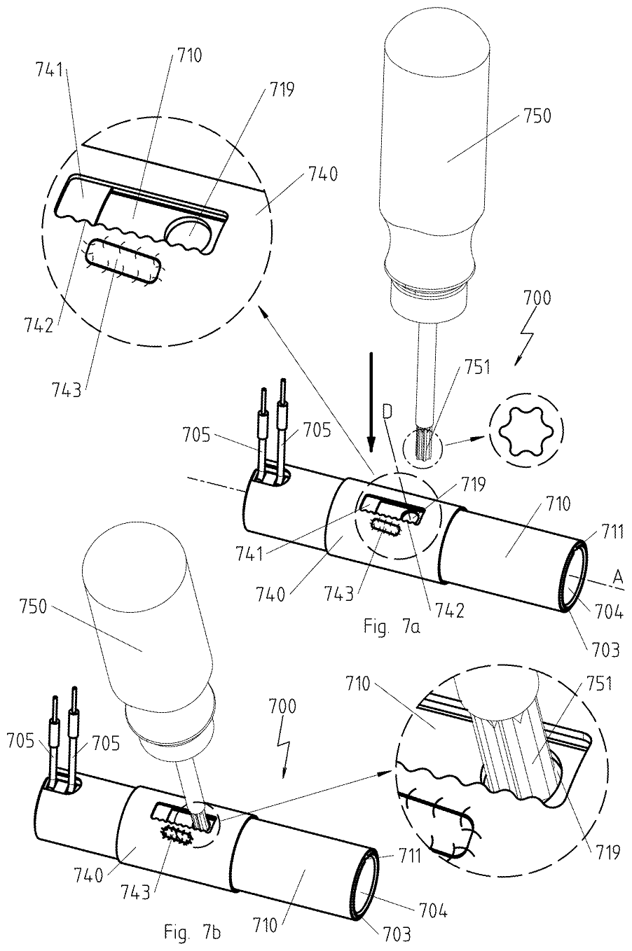

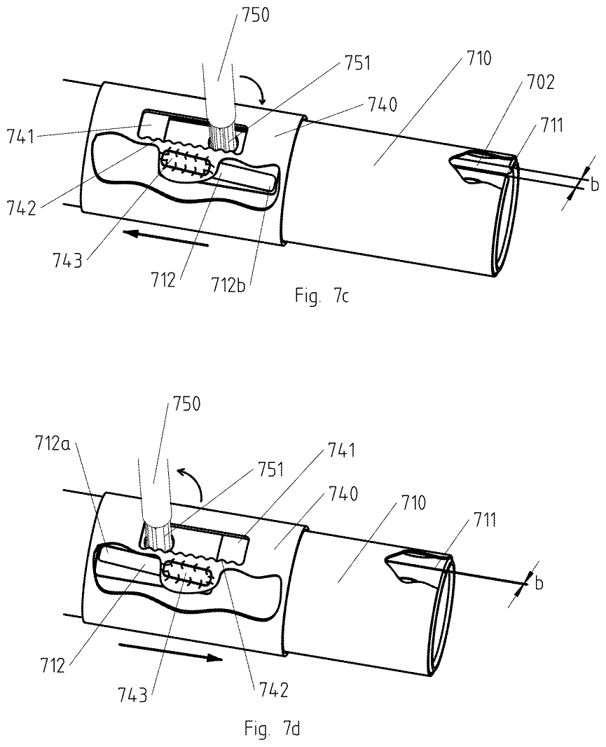

FIGS. 7a to 7d show a fifth embodiment of an electric heater 700 with a clamping device 720 according to a third type.

The electric heater 700 has essentially the shape of a hollow cylinder with a cut 701 constructed as a slot and penetrating longitudinally along its direction of profile specified by the cylinder axis that forms the axis A of the axial opening of the hollow cylinder. The electric heater 700 is basically similar to the electric heater 100, which is shown in FIGS. 1a and 1b: it has an outer sleeve that simultaneously forms the clamping sleeve 710, which are connected by means of lateral boundary surfaces 702 of the cut 711 and top and bottom lateral boundary surfaces 703 with the inner sleeve 704 of the hollow cylinder. In the interior space defined by these sleeve or boundary surfaces, the electric heating element 718, of which the end sections can be seen in FIGS. 7a and 7b, is embedded in a powder or granulate with good heat-conducting properties and is electrically insulated from the sleeve or boundary surfaces.

For this third type of clamping device 720, the clamping sleeve 710 has a mount 719, which defines an axis of rotation D perpendicular to the cylinder axis A of the hollow cylinder, so that a component 750 of the clamping device 720, which has a tooth structure 751 on its periphery, is mounted rotatably in the mount 719. The clamping sleeve 710 further has complementary engagement means 712, which can be seen especially well in the partially opened diagram of FIGS. 7c and 7d and is here constructed as a recess in the outer sleeve of the electric heater 700, whose distance of the cut 711 constructed as a slot increases from its first end 712a, which can be seen in FIG. 7d and is hidden in FIG. 7c, toward its second end 712b, which can be seen in FIG. 7c and is hidden in FIG. 7d.

The clamping device 720 also has a clamping slide 740. The clamping slide 740 has engagement means 743, which are here formed by a projection that is welded at a later time and is guided into the recess, and which are thus in engagement with the complementary engagement means 712 of the clamping sleeve 710. The clamping slide 740 further has an opening 741 which runs parallel to the axis A of the axial opening and has at least one edge running parallel to the axis A of the axial opening with a tooth structure 742 complementary to the tooth structure 751 and exposes the mount 719.

The clamping slide 740 also bridges the cut 711 constructed as a slot. Because it has a sleeve-shaped design and is adapted to the clamping sleeve 710 in the unclamped state, it is on the side of the cut 711 opposite the engagement means 743 in contact with the clamping sleeve 710 or can be brought into contact with the clamping sleeve 710 at least during the tensioning process.

As a consequence of this arrangement, it is produced that, when the component 750 of the clamping device 720, which has a tooth structure 751 on its periphery, is mounted rotatably in the mount 719, as shown in FIGS. 7c and 7d, through the interaction of the tooth structure 751 with the complementary tooth structure 742, the clamping slide 740 is displaced in the axial direction and therefore the width b of the cut 711 constructed as a slot is changed at least in one part of the axial displacement path.

In particular, in this third type of clamping device 720, there is the ability that the component 750 of the clamping device 720, which has the tooth structure 751 on its periphery, is not arranged permanently on the electric heater 700, but instead only when the tensioning effect is to be changed. In particular, the component 750 of the clamping device 720, which has the tooth structure 751 on its periphery, can be formed by a tool, which is, in perhaps the simplest case, just a star key wrench, as shown in FIGS. 7a to 7d.

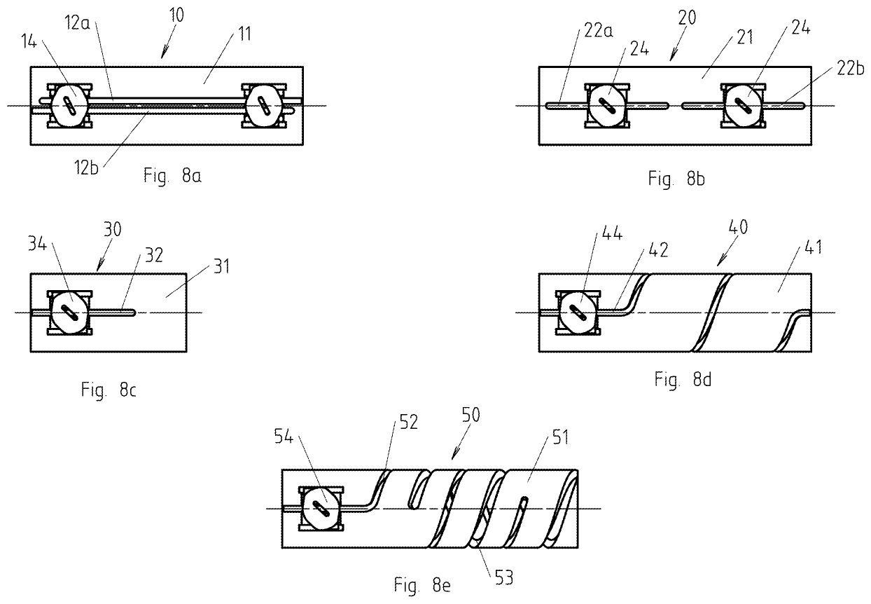

The clamping devices 10,20,30,40,50 shown in FIGS. 8a to 8e with clamping sleeves 11,21,31,41,51 and disks 14,24,34,44,54 are intended to illustrate examples of a few of the different forms that the cuts 12a,12b,22a, 22b,32,42,52 can have in the sense of this disclosure. To be emphasized here is that in the variants shown here, the width of the cuts is always relatively small in comparison to its length, but this is not absolutely necessary.

More specifically, for the clamping device 10 according to FIG. 8a, two cuts 12a,12b are provided that run essentially parallel to each other, but start from opposite ends of the clamping device 10 and end shortly before the respective other end of the clamping device 10.

For the clamping device 20 according to FIG. 8b there are also two cuts 22a,22b, which are arranged colinear to each other, but both do not extend out from the ends of the clamping sleeve 21, but instead are formed by two separate openings in the clamping sleeve 21.

For the clamping device 30 shown in FIG. 8c there is only one cut 32, which starts from one end of the clamping sleeve 31 and extends only up to just past the center of the clamping device 30.

In the example of the clamping device 40 shown in FIG. 8d, the cut 42, or also a spiral-shaped section, can be wrapped around a section of the clamping sleeve 41.

According to the example of FIG. 8e, there is, in addition to the cut 52 formed in the clamping sleeve 51 and constructed essentially identical to the cut 42, also a second, somewhat wider cut 53.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

10, 20, 30, 40, 50 Clamping device
11,21,31,41,51 Clamping sleeve
12a, 12b, 22a, 22b, 32, 42, 52, 53 Cut
14, 24, 34, 44, 54 Disk
100, 400, 500, 600, 700 Electric heater
102, 103, 602, 603, 702, 703 Boundary surfaces
104, 604, 704 Inner sleeve
110, 210, 310, 410, 510, 610, 710 Clamping sleeve
111,211,311,411,511,611,711 Cut
112 Projection
113 Stop
114, 114′, 214, 314, 414, 514, 614, 712 Complementary engagement means
119, 319, 619 Recess
120, 120′, 220, 320, 420, 520, 620, 720 Clamping device
121, 121′, 221, 321, 421, 521, 621 Disk
122, 122′, 222, 322, 422, 522, 622 Tool fitting
123, 123′, 223, 323, 423, 523, 623, 743 Engagement means
125, 125′ Push-in pieces
126 Wall section
140, 440, 640 Connecting line
214a, 214b, 314a, 314b End area
323a Fastening section
323b Feedthrough section
323c Projecting section
418, 518, 718 Electric heating element
419 Groove
614a, 712a First end
614b, 712b Second end
614c Pin
618 Guide pin
629 Through hole
719 Mount
740 Clamping slide
741 Opening
742 Complementary tooth structure
750 Component
751 Tooth structure
A Axis
D Axis of rotation
b Width

1. An electric heater with an axial opening for holding an object to be heated, the electric heater comprising:
an electric heating element, and
a clamping sleeve for generating an adjustable, radial force acting in a direction toward an axis of the axial opening, wherein the clamping sleeve of the electric heater is penetrated by a cut whose width can be changed by a clamping device, wherein at least one component of the clamping device is mounted or can be mounted so that the at least one component of the clamping device can rotate relative to the clamping sleeve about an axis of rotation perpendicular to the axis of the axial opening, wherein the at least one component interacts directly or indirectly with the clamping sleeve so that a rotation of the rotatably mounted or rotatably mountable at least one component of the clamping device changes a width of the cut.

2. The electric heater according to claim 1,
wherein the rotatably mounted or rotatably mountable at least one component of the clamping device is a disk with at least one engagement means, wherein the engagement means interacts with at least one complementary engagement means arranged on the clamping sleeve.

3. The electric heater according to claim 2,
wherein the at least one engagement means comprises projections and the at least one complementary engagement means comprises recesses, the recesses comprised of grooves, cuts, or through holes.

4. The electric heater according to claim 3,
wherein the projections are formed by components fastened to the disk or components fastened to the clamping sleeve.

5. The electric heater according to claim 3,
wherein the projections and the recesses are in contact with each other at least in sections with an undercut, so that the disk is fixed.

6. The electric heater according to claim 3,
wherein the recesses are curved.

7. The electric heater according to claim 6,
wherein the curvature of the recesses varies.

8. The electric heater according to claim 3,
wherein the recesses form the at least one complementary engagement means arranged on the clamping sleeve and run in a separate part fixed on the clamping sleeve.

9. The electric heater according to claim 1,
wherein the clamping device has a tool fitting, the tool fitting positioned on the axis of rotation of the at least one component of the clamping device.

10. The electric heater according to claim 1,
wherein the clamping sleeve has a recess in which the clamping device is arranged at least in sections.

11. The electric heater according to claim 2,
wherein the at least one complementary engagement means on the clamping sleeve bridges the cut, the at least one complementary engagement means includes a first end positioned on one side of the cut, which is connected to the clamping sleeve, the at least one complementary engagement means includes a second end on an opposite side of the cut, the second end engages directly or indirectly the disk.

12. The electric heater according to claim 1,
wherein the clamping sleeve has a mount, the mount defines the axis of rotation perpendicular to the axis of the axial opening, so that the at least one component of the clamping device, which has, on its periphery, a tooth structure, is rotatably mountable in the mount, so that the clamping sleeve further has a complementary engagement means, whose distance from the cut increases from its first end toward its second end and that the clamping device further has a clamping slide, wherein the clamping slide
has clamping slide engagement means, the clamping slide engagement means are in engagement with the complementary engagement means of the clamping sleeve,
has an opening, the opening runs parallel to the axis of the axial opening, and has at least one edge running parallel to the axis of the axial opening with a complementary tooth structure complementary to the tooth structure of the clamping device, the opening exposes the mount, so that the at least one component of the clamping device is arranged or can be arranged in the mount,
bridges the cut, and
is in contact or can be brought into contact on the side of the cut with the clamping sleeve opposite the complementary engagement means,
so that, when the at least one component of the clamping device, which has, on its periphery, the tooth structure, is rotatably mounted in the mount and is turned, the electric heater configured such that interaction of the tooth structure with the complementary tooth structure pushes the clamping slide in an axial direction and therefore the width of the cut is changed at least on one part of an axial displacement path.

13. The electric heater according to claim 3, wherein the at least one complementary engagement means comprises projections and the at least one engagement means is comprised of recesses, the recesses comprised of grooves or through holes.
